(19) United States
(12) Patent Application Publication
(10) Pub. No.: US 2011/0061738 A1
(43) Pub. Date: Mar. 17, 2011

(54) Hod System

(75) Inventors: Jon Strimling, Bedford, NH (US); Randell Drane, Winchester, MA (US); Mark MacLean, Andover, MA (US)

(73) Assignee: Pelletsales.com, LLC, Goffstown, NH (US)

(21) Appl. No.: 12/718,597

(22) Filed: Mar. 5, 2010

Related U.S. Application Data
(60) Provisional application No. 61/157,766, filed on Mar. 5, 2009.

(51) Int. Cl. F16L 37/56

(52) U.S. Cl. 137/1; 137/594

(57) ABSTRACT

A system and method for transporting a bulk solid biomass fuel. The biomass transport system comprises a remote storage bin (RSB), a biomass transfer system, and a vacuum source. The RSB contains a quantity of fuel and a controllable dispensing valve configured to dispense a controlled rate of the fuel into a first pipe. The vacuum source provides a stream of air through a second pipe. The biomass transfer system comprises a register and a hod. The register is coupled to a support surface, a first opening be fluidly coupled to the first pipe, and a second opening fluidly coupled to the second pipe. The hod is removably fluidly coupled to the register and comprises a body defining a sealed cavity for storing a user selected quantity of fuel; a feed pipe disposed within the sealed cavity and configured to be fluidly coupled to the first opening to receive air and the fuel from the remote storage bin; and an air pipe disposed within the sealed cavity, the air pipe configured to be fluidly coupled to the second opening such that substantially only air exits the sealed cavity and the fuel is stored within the sealed cavity. The method comprises applying a vacuum to the second pipe to create a flow of air and dispensing a controlled rate of fuel from the remote storage bin into the first pipe using a controllable dispensing valve; and separating the fuel from the flow of air such that substantially only air exits the sealed cavity through the second pipe and the fuel is stored within the sealed cavity.

### CROSS-REFERENCE TO RELATED APPLICATIONS

This application claims the benefit of the filing date of co-pending U.S. Provisional Patent Application Ser. No. 61/157,766, filed on Mar. 5, 2009 and entitled SELF-FILLING PELLET HOD SYSTEM, the teachings all of which are fully incorporated herein by reference.

### TECHNICAL FIELD

The present disclosure relates to a self filling pellet hod for transferring bulk (i.e., loose) biomass fuels from a storage bin to a biomass appliance.

### BACKGROUND

Biomass heating fuel, e.g., wood pellets, may be purchased in fixed size bags, e.g., by weight or volume, or in bulk, i.e., loose. Bags may generally be sized so that the contents of at least one bag may fit into a fuel reservoir of a biomass appliance, e.g., a pellet stove. Such bag sizing may provide convenience in that partial bags need not be accommodated. Standard bags are generally sized to contain about forty pounds of biomass heating fuel. A disadvantage of fixed size bags is that forty pounds may be too heavy for some people to lift and/or carry.

A further disadvantage of bags is waste from packaging (i.e., the bags themselves). Providing bulk biomass heating fuels may eliminate such packaging waste. However, eliminating the bags may also eliminate a convenient way of providing the biomass fuel to the appliance from, e.g., an end-user storage bin. It may therefore be desirable to provide a way to move an adjustable quantity of biomass fuel from the end-user storage bin to the appliance.

### BRIEF DESCRIPTION OF THE DRAWINGS

These and other features and advantages will be better understood by reading the following detailed description, taken together with the drawings wherein:

FIG. 1 illustrates one embodiment of a biomass transport system consistent with the present disclosure;

FIG. 2A illustrates a front cross-sectional view of one embodiment of a biomass transfer system as generally shown in FIG. 1;

FIG. 2B illustrates a side cross-sectional view of the biomass transfer system as generally shown in FIG. 2A;

FIG. 3A illustrates a top cross-sectional view of one embodiment of a register consistent with the biomass transfer system as generally shown in FIGS. 2A-2B;

FIG. 3B illustrates a bottom perspective view of one embodiment of a register consistent with the biomass transfer system as generally shown in FIG. 3A;

FIG. 3C illustrates another bottom perspective view of one embodiment of a register consistent with the biomass transfer system as generally shown in FIG. 3A;

FIG. 4 illustrates a cross-sectional view of one embodiment of a hod consistent with the biomass transfer system as generally shown in FIGS. 2A-2B;

FIG. 5 illustrates a top cross-sectional view of the hod consistent with FIG. 4;

FIG. 6A illustrates a bottom cross-sectional view of the hod consistent with FIG. 4;

FIG. 6B illustrates a side cross-sectional view of the hod consistent with FIG. 4;

FIG. 7 illustrates a side cross-sectional view of the hod having a sensor array consistent with FIG. 4;

FIG. 8 illustrates a side cross-sectional view of a sensor array consistent with FIG. 7;

FIG. 9 illustrates another side cross-sectional view of the sensor array consistent with FIG. 8;

FIG. 10 illustrates one embodiment of a biomass transport system including a central controller consistent with present disclosure;

FIG. 11 illustrates a cross-sectional view of one embodiment of a dispensing valve consistent with present disclosure; and

FIG. 12 illustrates a cross-sectional view of one embodiment of an ash pod consistent with the present disclosure.

### DETAILED DESCRIPTION

Aspects of the present disclosure relate to a self filling pellet hod configured for moving bulk, i.e., loose, pelletized and/or granularized fuels from a storage bin, which may be remote from an appliance, to an appliance. The fuel may include, but is not limited to, any pelletized and/or granularized solid fuel such as, but coal (e.g., anthracite coal) and biomass fuel. As used herein, biomass fuel is intended to refer to solid animal matter and/or solid fuel plant (such as, but not limited to, numerous types of plants including miscanthus, switchgrass, hemp, corn, poplar, willow, sorghum, sugarcane, a variety of tree species, and/or torrefied biomass fuel, e.g., e-coal or eco-coal) that can be combusted as fuel. The term biomass fuel is not intended to refer to fossil fuels which have been transformed by geological processes into substances, such as coal, petroleum or natural gas. Although fossil fuels have their origin in ancient biomass, they are not considered biomass fuel as used herein and by the generally accepted definition because they contain carbon that has been “out” of the carbon cycle for a very long time. Bulk as used herein may refer to a quantity loose of fuel that is not associated with a fixed size, e.g., forty pound bag. In other words, the material may be loose and not in bags. Although, in the exemplary embodiments described below, reference is made to biomass fuel (e.g., wood pellets), the self-filling pellet hod system may be used for any solid fuel.

By way of an overview, a self-filling hod consistent with at least one embodiment herein may be further configured to allow a user to easily transport a quantity of solid biomass fuel from a remotely located storage bin to an appliance, such as, but not limited to, a pellet stove or the like. In particular, the self-filling pellet hod may be configured to be coupled to a biomass fuel transport system which may transport the solid biomass fuel from the remotely located storage bin to the self-filling hod. The self-filling hod may be coupled to the biomass fuel transport system at a position relatively close to the appliance, for example, in the same room or in a closet adjacent to or connected to the room with the heating appliance. The remotely located storage bin may be configured to contain and/or store a relatively large quantity of solid biomass fuel (e.g., a quantity which is several times greater than the maximum quantity of the self-filling hod). As used herein, the term “remotely located” is intended to refer to a location that is in a different room than the appliance. For exemplary purposes only, the term “remotely located” may refer to a storage bin located in a different room, on a different floor or outside of a building. Once the self-filling hod has been filled with a desired quantity of solid biomass fuel, the self-filling hod may be decoupled from the biomass fuel transport system.

As a result, a user may easily transport a desired quantity of solid biomass fuel from a location proximate to the appliance. The quantity of solid biomass fuel to be transported in the self-filling hod may be selected by the user based on, for example, the desired overall weight of the self-filling hod with the biomass fuel, the desired volume of solid biomass fuel to be transported, and/or the capacity of the appliance. As to be discussed herein, the self-filling hod may also reduce and/or minimize the amount of particulate introduced into the appliance and/or released into the room containing the appliance, for example, by removing some or all of the particulate biomass fuel (e.g., biomass fuel dust). As may be appreciated, fine dust particles may clog air passages in pellet stoves if introduced along with the fuel.

The following figures have been selected to provide a better understanding of the present disclosure. It should be understood that some of the components have not been shown in various figures for reasons of clarity.

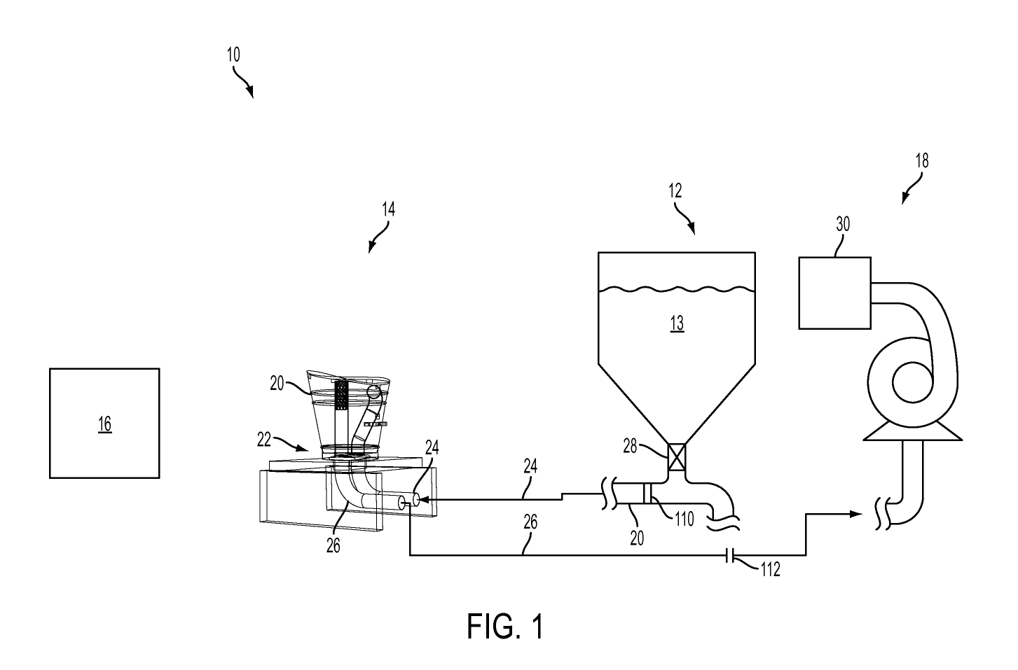

Turning now to FIG. 1, one embodiment of a biomass transport system 10 consistent with the present disclosure is generally illustrated. The biomass transport system 10 may comprise a remote storage bin 12, a biomass transfer system 14 disposed proximate to an appliance 16, and a vacuum source 18. The remote storage bin 12 may be configured to contain a relatively large quantity of a solid biomass fuel 13 (e.g., but not limited to, wood pellets). The location of the remote storage bin 12 may be selected based one or more of the following factors: aesthetics (e.g., the remote storage bin 12 may be located generally out of sight), size/space consideration (e.g., the storage bin 12 may be relatively large in size and this size may dictate where it may be positioned), ease of refilling (e.g., the location may be selected to facilitate periodic refilling of the storage bin 12 with solid biomass fuel 13) as well as maintenance and/or installation considerations. While the volume of the remote storage bin 12 may vary depending on the particulars of the installation, the remote storage bin 12 may be capable to hold up to 30-40 tons of fuel, e.g., from 40 lbs to 30 tons, including any range or value therein.

The biomass transfer system 14 may comprise a hod 20 and a register 22. The pod may be configured to contain a predetermined quantity of solid biomass fuel 13 from the remote storage bin 12, which may ultimately be loaded into the appliance 16 where it may be combusted or otherwise used. The register 22 may be configured to removably fluidly couple the hod 20 to the remote storage bin 12 and the vacuum source 18.

For example, the register 22 may be configured to fluidly couple the hod 20 to a first and a second pipe 24, 26. The first pipe 24 (e.g., a feed pipe) may be configured to extend from the register 22 to the remote storage bin 12. The second pipe 26 (e.g., an air or vacuum pipe) may extend from the register 22 to the vacuum source 18. The vacuum source 18 (which may include a vacuum pump as part of a central vacuuming system and/or a dedicated vacuum pump) may be configured to provide a stream of air flowing from and/or across the remote storage bin 12 and through the biomass transfer system 14 to the vacuum source 18. As generally illustrated in FIG. 1, the biomass transfer system 14 and the remote storage bin 12 may be arranged in series relative to the vacuum source 18 (i.e., the biomass transfer system 14 may be located upstream from the vacuum source 18 and the remote storage bin 12 may be located upstream from the biomass transfer system 14).

The remote storage bin 12 may be configured to dispense a controlled rate of solid biomass fuel 13 into the feed pipe 24 (e.g., by way of a controllable dispensing valve or the like 28) and into the air stream. The air stream may be sufficient to create a fluidizing gas flow with the fuel 13 such that the fuel 13 may be transported within the feed pipe 24 to the biomass transfer system 14 where it is enters the hod 20 by way of the register 22. The hod 20 may be configured to generally separate the fuel 13 from the air stream such that the fuel 13 is collected inside the hod 20. The air stream exits the hod 20 by way of the air pipe 26 (via the register 22) and is drawn to the vacuum source 18. Optionally, the air exiting the vacuum source 18 may be filtered to remove any fuel particulates and may be returned to the same place it was drawn, thereby eliminating drawing unconditioned air to/from conditioned spaces. The filter 30 may include a self-shedding relatively fine filter (e.g., but not limited to, a bag filter or the like) that may be configured to collect relatively fine particles that may be included with the biomass heating fuel. The biomass transport system 10 may be configured to control the amount of fuel 13 transported from the remote storage bin 12 to the hod 20 and/or to generally prevent fuel 13 from forming blockages within the pipes 24, 26, for example, by regulating the dispensing valve (e.g., a dispensing auger, rotary air lock or other method of metering fuel) 28.

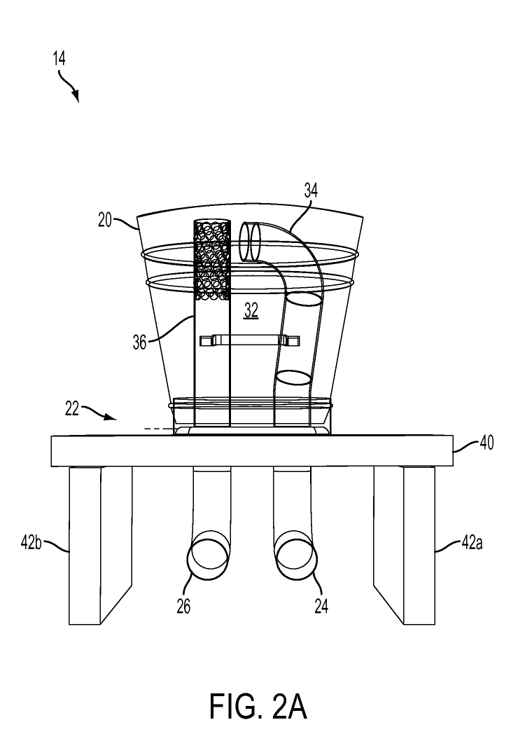

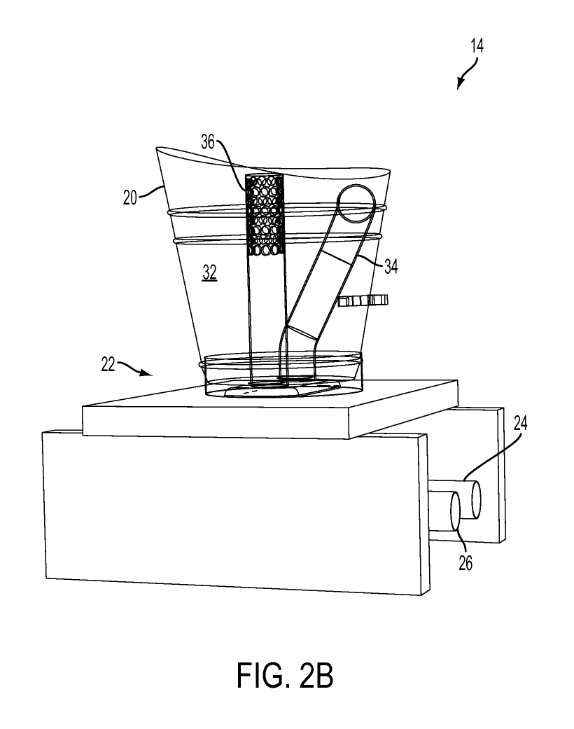

Turning now to FIGS. 2A and 2B, one embodiment of a biomass transfer system 14 which may be used in the biomass transport system 10 is generally illustrated. As discussed above, the biomass transfer system 14 may comprise a hod 20 configured to be removably coupled to a register 22. The hod 20 may define an interior cavity 32 configured to hold a quantity of fuel 13 (not shown for the sake of clarity) and may include a feed inlet 34 and an air outlet 36. The register 22 may be configured to form a removable, substantially air-tight connection between the hod 20 (and in particular, the feed inlet 34 and air outlet 36) and the feed pipe 24 and the air pipe 26, respectively. As described herein, the register 22 may comprise a floor register and/or a vertical interface on a wall.

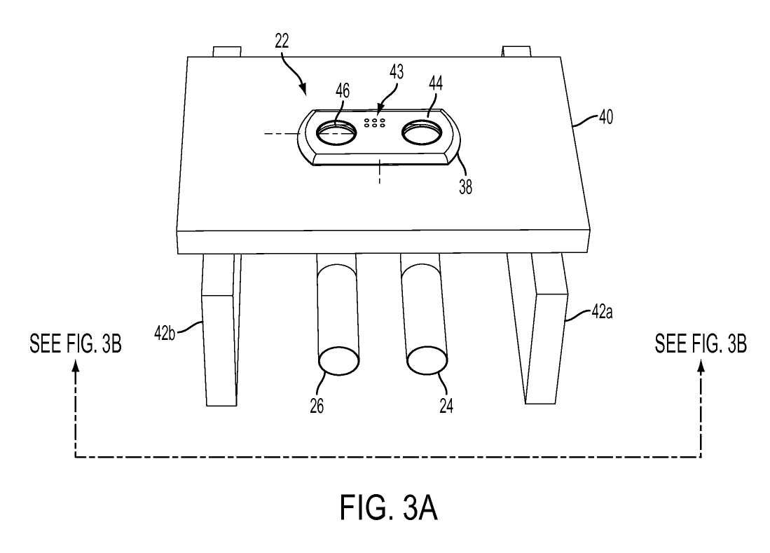

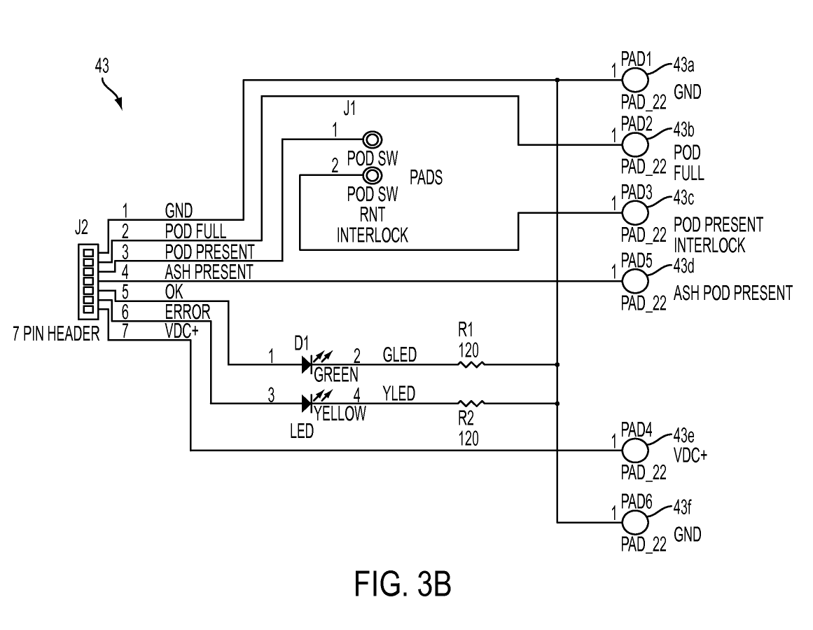

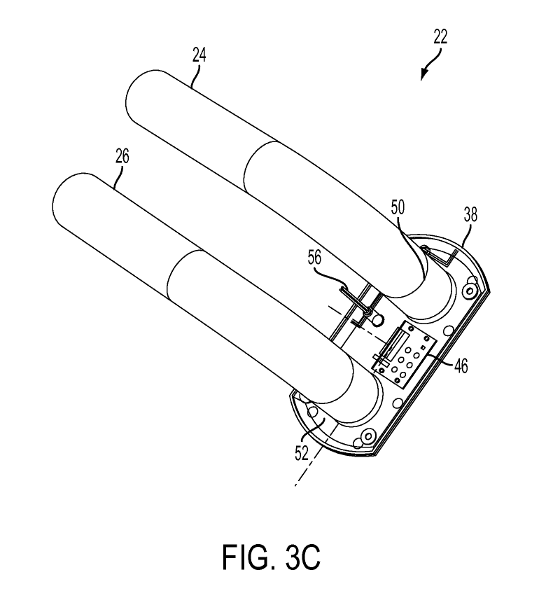

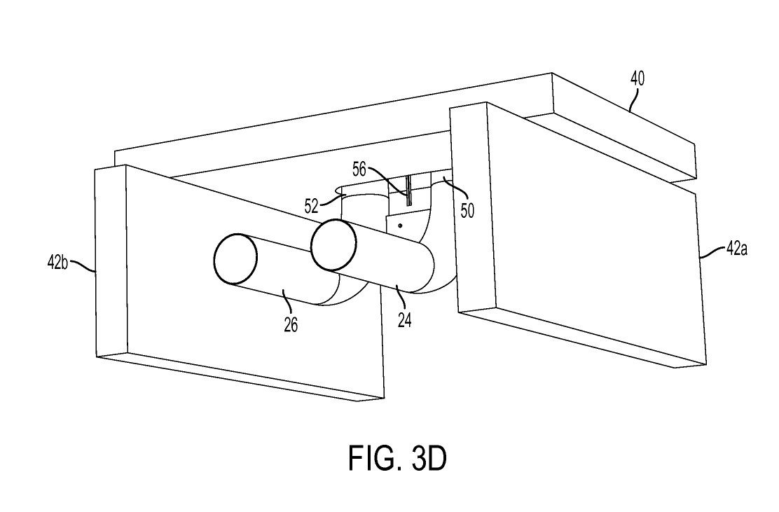

One embodiment of the register 22 is generally illustrated in FIGS. 3A, 3B, 3C, and 3D. The register 22 may include a first and a second opening 44, 46 which terminate the feed line 24 and air line 26, respectively. It may be appreciated that only a portion of the lines 24, 26 are illustrated for clarity. The first and second openings 44, 46 may be disposed within one or more base plates 38 configured to align the hod 20 (and in particular, the openings of the feed line 24 and air outlet 36, not shown) with the first and second openings 44, 46 in order to facilitate the seal there between. The base plate 38 may include a chamfered edge portion configured to align the hod 20 with the openings 44, 46. For example, the base plate 38 may also be configured to allow the hod 20 to be aligned in only one position relative to the base plate 38 or may be configured to allow the hod 20 to be aligned in multiple, discrete positions that may interact with the controls as discussed herein. The base plate 38 may be secured to a support surface 40, such as, but not limited to, a floor, wall, shelf, or the like. As shown the floor 40 may be supported by one or more floor joist and/or stringers 42a, 42b.

Optionally, the base plate 38 may include one or more electrical connections, switches, and/or sensors configured to control the flow of fuel 13 from the remote storage bin 12 to the hod 20. For example, the base plate 38 may include one or more electrical connections 43. The electrical connections 43 may be configured to transmit signals from the hod 20 to a central controller, the vacuum source 18 and/or the remote storage bin 12. For example, one or more of the electrical connections 43 may be configured to transmit a signal to the vacuum source 18 to turn on/off the vacuum source 18. One or more of the electrical connections 43 may be configured transmit a signal to the remote storage bin 12 to control the flow of fuel 13 from the remote storage bin 12. For example, once the hod is coupled to the feed line 24 and the air line 26 and that the vacuum source 18 is on, a signal may be transmitted to the remote storage bin 12 to begin dispensing fuel 13 into the feed line 24 (e.g., to control the rate of fuel 13 dispensed by the regulating valve 28 into the feed pipe 24).

FIG. 3B schematically illustrates one embodiment of a plurality of electrical connections 43a-f. In particular, the electrical connections 43a-f may include a ground connection 43a, a pod full connection 43b (indicating that the pod 20 is full of fuel), a pod present interlock connection 43c (indicating that the pod 20 is properly coupled to the register 22), an ash pod present connection 43d (indicating that an ash pod is properly coupled to the register 22 as described herein), a positive voltage connection 43e and another ground connection 43f.

Turning now to FIG. 3C, a bottom view of the register 22 is illustrated with the floor 40 and stringers 42a, 42b removed. The register 22 may optionally include one or more register printed circuit boards (PCBs) 46. The register PCB 46 may be configured to provide wire termination for the electrical connections 43 and provide interlock functions. According to another embodiment, the register PCB 46 may optionally be configured to interpret and/or communicate signals with the remote storage bin 12 and/or the vacuum source 18. For example, the register PCB 46 may be configured to determine when the hod 20 is sealingly coupled to the register 22 as well as the orientation of the hod 20 relative to the register 22. The register PCB 46 may also be configured to open/close one or more valves in the feed line 24 and/or air line 26. For example, the feed line 24 and/or air line 26 may each include a valve 50, 52, respectively, as generally shown in FIGS. 3C and 3D. The valves 50, 52 may seal closed the feed line 24 and/or air line 26 to prevent debris from entering therein and/or to prevent vacuum loss/isolate the lines 24, 26 (e.g., in an applications in which the feed line 24 and/or air line 26 are coupled to other systems or the like).

The register 22 may also optionally include one or more reed sensors, hall sensors, radio frequency identifier or the like 56. The reed sensor 56 may form an electrical switch operated by a magnetic field (e.g., a magnetic field generated by a magnet in the hod 20). The reed sensor 56 may therefore function as an interlock switch to switch on/off power to the electrical connections 43 (thus minimizing the potential of an accidental electrical shock). For example, a combination of signals from the reed and/or hall sensors and/or electrical connections 43 may be used to verify the identity and/or authenticity of the pod placed on the register 22 to prevent system activation without a pod in place. The system may be advantageously configured to prevent operation (e.g., prevent drawing a vacuum) without a pod coupled to the register 22 (e.g., to prevent the register 22 from being used as a vacuum port for ash or the like).

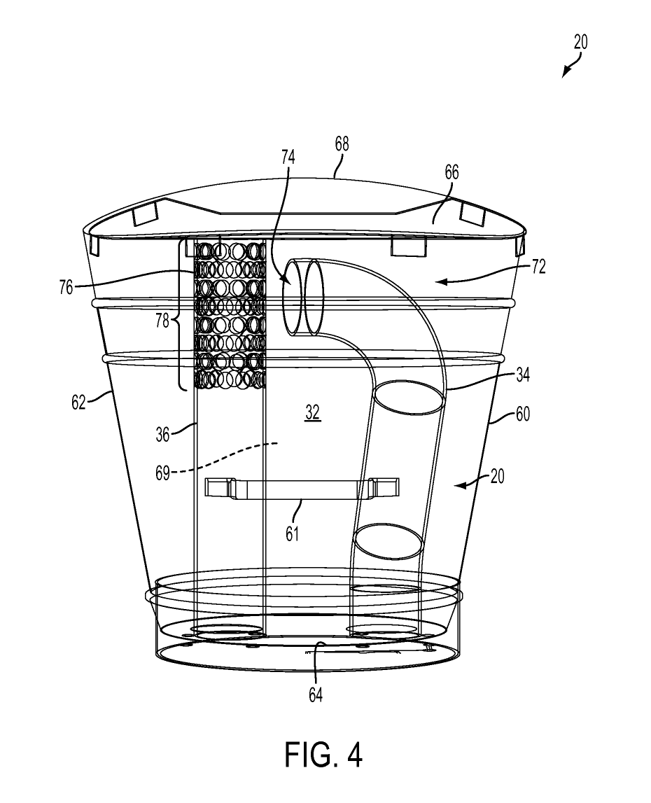

Turning now to FIG. 4, a side perspective view of one embodiment of a hod 20 is generally illustrated. The hod 20 may include a body 60 defining an interior cavity 32 configured to contain a quantity of fuel 13 (not shown for clarity). The body 60 may include one or more sides or side walls 62, a bottom or base 64, and a top 66. The exterior of the body 60 may include one or more handles 61 (for example, but not limited to, a handle on the sidewall 62 and/or the top 66) configured to facilitate transportation of the hod 20. When coupled to the feed line 24 and the air line 26 (e.g., by way of the register 22), the body 60 may form a generally sealed cavity 32 (i.e., the cavity 32 is sealed so that material may only enter/exit the cavity 32 through the feed line 24 and the air line 26). The overall exterior shape of the hod 20 may depend on a variety of factors including, but not limited to, the desired maximum quantity of fuel 13 to be contained therein, the desired height, width, and/or length of the hod 20, aesthetic considerations, or the like.

For exemplary purposes, the top 66 may be disposed generally opposite the base portion 64. The top 66 and the opposing base portion 64 may be substantially parallel. The hod 20 may optionally include a lid, lip and/or funnel 68 which may extend generally outwardly and away from the top 66 to facilitate unloading of the fuel 13 contained within the hod 20 into the appliance 16. The sidewalls 62 may be disposed between the top 66 and the opposing base portion 64. The top 66 may have an area greater than an area of the base portion 64. The sidewall 62 may include a back portion 69 and a front portion 70. The back portion 69 may be substantially perpendicular to the top 66 and the opposing base portion 64. The front portion 70 may join the top 66 at an angle less than about ninety degrees. As generally shown in FIG. 4, a cross-section of the hod 20 from the top 66 to near the base portion 64 may be substantially trapezoidal. The front portion 70 may be substantially perpendicular to the base portion 64 adjacent to the base portion 64 and may extend outward, relative to the back portion 69, a distance from the base portion 64 to facilitate pouring of the fuel into an appliance 16. The top 66, base portion 64 and sidewall(s) 62 of the hod 20 may define an interior cavity/chamber/volume 32 of the hod 20.

The hod 20 may also include at least one feed inlet 34 configured to be coupled to the feed line 24 and at least one air outlet 36 configured to be coupled to the air line 26, for example, as discussed herein. A proximal end of the feed line 24 and/or air outlet 36 may generally extend upwardly and away from the base portion 64 and terminate at a distal end disposed generally proximate the top 66. The distal end of the feed line 24 may include a feature configured to direct the path of fuel 13 and/or air as the fuel 13 and/or air flow into the chamber 32 of the hod 20. For example, the distal end of the feed line 24 may define an arcuate portion 72 having a generally arc or curved shape. The arcuate portion 72 may be configured to facilitate the separation of the fuel 13 from the air when the hod 20 is coupled to the remote storage bin 12 and vacuum source 18. For example, the arcuate portion 72 may be configured to direct the flow of fuel 13 and/or air in a direction substantially parallel to the top 66 and/or sidewall 62 of the hod 20. The directionality of the flow of the fuel 13 and air may reduce friction and/or turbulence in the fuel 13 and/or air flow and may facilitate relatively uniform and/or filling of the interior volume 32 of the hod 20. In addition (or alternatively), the arcuate portion 72 may direct the flow of fuel 13 and/or air leaving the feed line 24 generally towards the base portion 64. The feed line 24 may also be arranged to generally discharge the fuel 13 and/or air such that it generally avoids direct line of sight with the air outlet 36.

The air outlet 36 may be configured to be coupled to the vacuum source 18 (e.g., by way of the register 22 and the air line 24). The distal end of the air outlet 36 may be terminated in a filter 76. The filter 76 may include a relatively coarse filter that permits fines and air to pass into the air outlet 36 but substantially prevents the fuel 13. At the distal end of the air pipe 26, a self shedding filter 30 may collect the fines (dust).

The exit 74 of the feed line 24 and the entrance 78 of the air outlet 36 may be arranged to allow the cavity 32 to fill up with a desired amount of fuel 13. For example, the exit 74 and entrance 78 may be configured to at or above the maximum height of the fuel 13 when the hod 20 is filled to operating capacity. As such, air entering from the feed line 24 may be allowed to exit the air outlet 36. This arrangement may prevent blockage of the feed line 24 caused by fuel 13 not being able to be transported into the hod due to the entrance 78 of the air outlet 36 becoming blocked/plugged by an excessive amount of fuel 13 in the cavity 32.

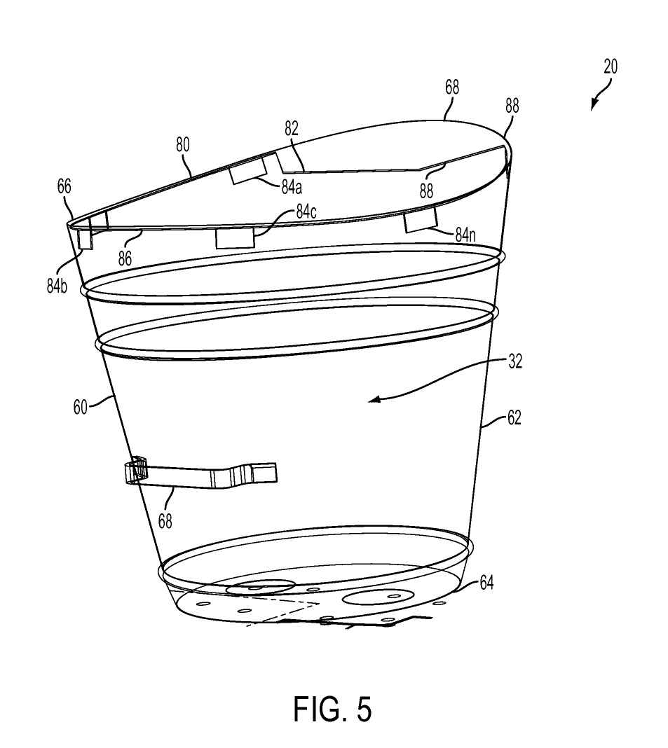

Turning now to FIG. 5, a perspective top end view of the hod 20 is generally shown. The top 66 may include a fixed portion 80 and self-sealing lid 82. The fixed portion 80 may be fixedly coupled to the sidewall 62. For example, the fixed portion 80 may be removably coupled to a portion of the sidewall 62 using one or more fasteners 84a-n and a seal 86. The seal 86 may include any type of seal capable of forming a generally air-tight seal between the fixed portion 80 and the sidewall 62 and may include a resilient deformable material such as, but not limited to, rubber, foam, or the like. The fixed portion 80 may be removably secured to sidewall 62 to provide increased access to the chamber 32.

The self-sealing lid 82 may be hingedly coupled to the fixed portion 80. The self-sealing lid 82 may be configured to close, i.e., seal the lid 82 to the front portion of the sidewall 62 of the hod 20 when the hod 20 is receiving fuel 13. The self-sealing lid 82 may be configured to open, i.e., create a continuous path from the cavity 32 of the hod 20 to the outside, after filling, for pouring the fuel 13 into an appliance 16. The self-sealing lid 82 may arrange to empty the fuel 13 proximate to the lip 68 and may be sized to limit a flow rate of the fuel 13 during the pouring. A seal 88 may also be provided to form a generally air-tight seal between the lid 82 and the sidewall 62 and may include a resilient deformable material such as, but not limited to, rubber, foam, or the like. The lid 82 may optionally include one or more retaining magnets, fasteners, or the like to keep the lid 82 sealed and/or to hold the lid 82 open to improve pour accuracy. The lid 82 may optionally be biased (e.g., by a spring or the like) so that the lid 82 is self closing normally, but self opening when pouring.

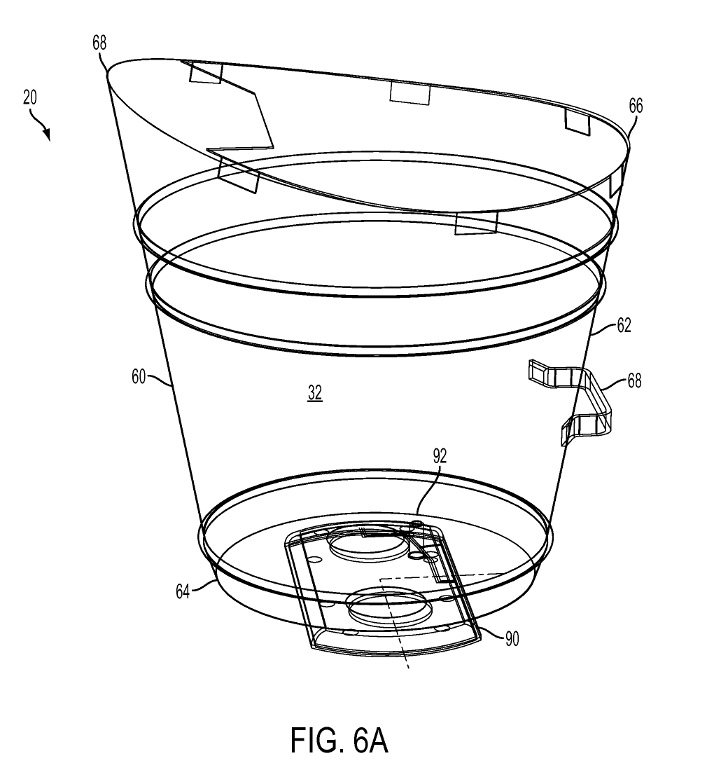

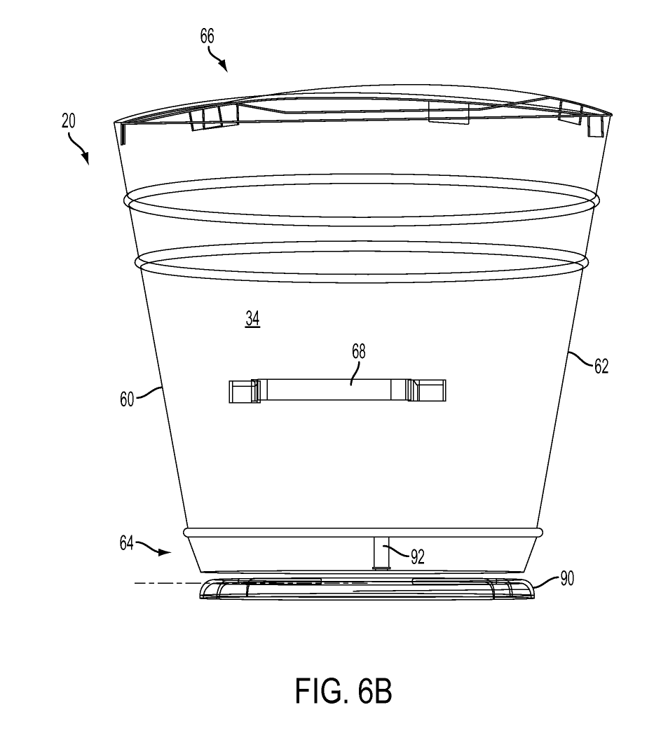

A perspective bottom end view of the hod 20 is generally illustrated in FIGS. 6A and 6B. The base portion 64 may optionally include one or more guide plates 90 configured to receive at least a portion of the base plate 38 and generally align the feed inlet 34 and air outlet 36 (neither of which are shown for clarity) with the feed line 24 and air line 26, respectively and facilitate forming a seal there between. The guide plate 90 may extend across only a portion of the base portion 64 as generally illustrated or may be substantially coextensive with the base portion 64.

According to one embodiment, the base plate 38 may protrude generally outwardly from the floor 40 as generally illustrated in FIG. 3A. Turning back to FIGS. 6A and 6B, the guide plate 90 may have an interior cavity configured to receive the base plate 38 and therefore align the feed inlet 34 and air outlet 36 with the feed line 24 and air line 26, respectively. The base plate 38 and the guide plate 90 may form a lock-and-key type arrangement in which they 38, 90 can only be aligned in one orientation. Alternatively, the base plate 38 and the guide plate 90 may form a modified lock-and-key type arrangement in which the base plate 38 and the guide plate 90 can only be aligned in two or more discrete orientations (for example, but not limited to, a first orientation corresponding to a fuel fill mode and a second orientation corresponding to an inactive mode or a different fuel fill amount as discussed herein). The guide plate 90 and/or the base portion 64 may optionally include one or more magnets 92 which may be detected by one or more reed switches or the like 56 (FIGS. 3C and 3D). The magnets 92 and reed switches 56 may be configured to determine when the hod 20 is coupled to the register 22 and/or the orientation of the hod 20 relative to the register 22 (e.g., to determine whether the hod is in the first orientation or the second orientation).

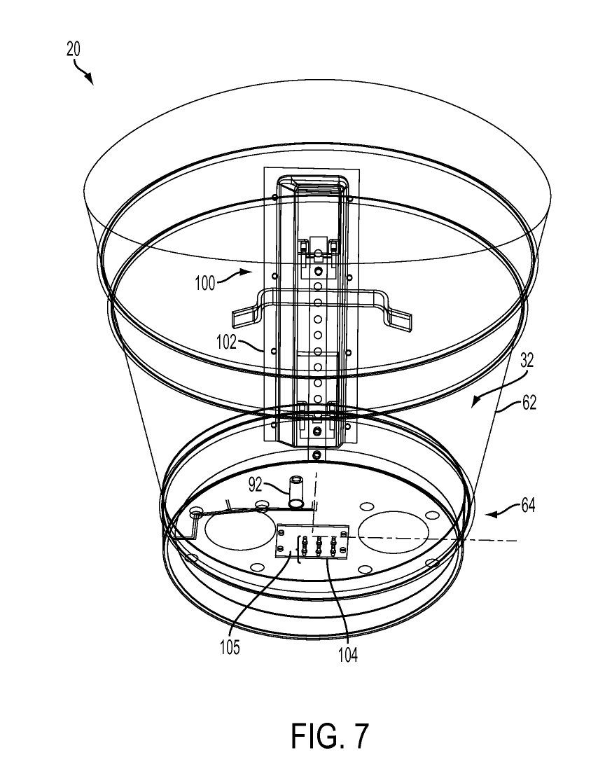

Turning now to FIGS. 7-9, one embodiment of a hod sensor system 100 is generally illustrated. As discussed herein, the hod 20 may be configured to communicate with the remote storage bin 12 and/or the vacuum source 18 to commence and/or terminate the filling of the hod 20 with fuel 13. The hod sensor system 100 may comprise one or more sensors disposed within a sensor shroud 102 and optionally a hod PCB 104. According to one embodiment, the hod PCB 104 may be configured to provide electrical terminations for the various sensors and/or wires within the hod 20.

The hod PCB 104 may optionally be configured to receive signals from the sensors in the sensor shroud 102 and may interpret these signals to detect when the chamber 32 of the hod 20 has reached a desired quantity/volume of fuel 13. The hod PCB 104 may be configurable based on user preferences. For example, a user may be able to configure/set the hod PCB 104 to select the desired quantity of fuel 13 to be dispensed into the cavity 32 of the hod 20, to select the desired fuel flow rate, the desired air flow rate, or even the desired type of fuel 13 or desired source of fuel (for example, if the system includes multiple remote storage bins 12). According to one embodiment, the hod PCB 104 may include a timer configured to provide a flow of fuel 13 from the remote storage bin 12 to the hod 20 based on a desired amount of fill time (which may be based on the fuel flow rate from the remote storage bin 12).

The hod PCB 104 may also include one or more connections 105 for transmitting signals to the remote storage bin 12 and/or the vacuum source 18. For example, the hod PCB 104 may include a plurality of contacts 105 configured to be electrically and/or magnetically coupled to the pads 44 of the register 22. The hod 20 and the register 22 may be configured to provide a flow of clean air (i.e., air substantially without fuel 13) across the contacts 44, 105 when the hod 22 is coupled to the register 22 in order to reduce/eliminate build up of material (e.g., fuel particulates and/or dust) on the contacts 44, 105. The contacts 44, 105 may have a convex shape which may be self cleaning.

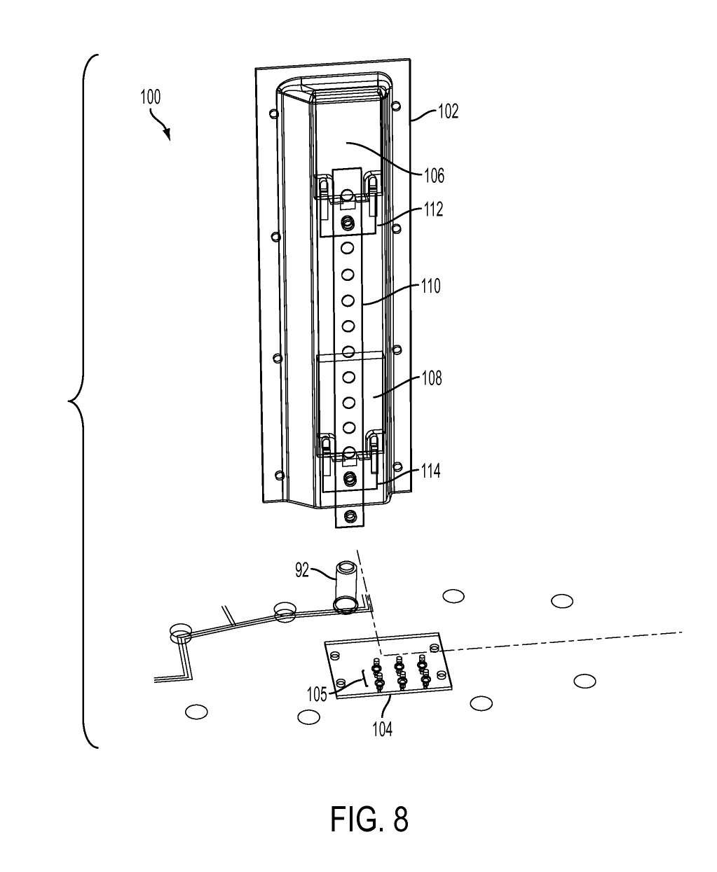

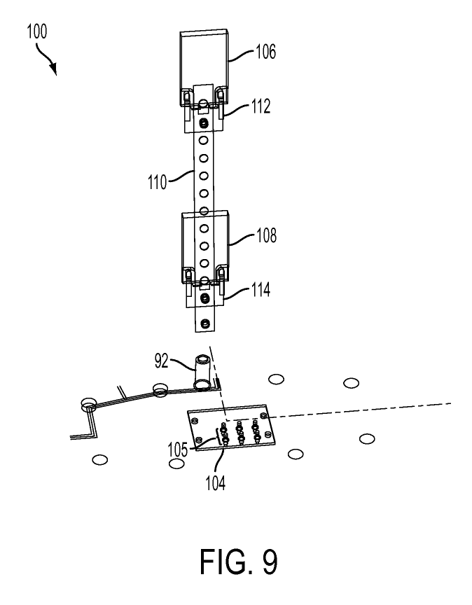

The sensor shroud 102 may be disposed within the chamber 32 of the hod 20 and/or outside of the chamber 32. As shown, the sensor shroud 102 may be coupled to a sidewall 62. An exploded view of one embodiment of the hod sensor system 100 is generally illustrated in FIG. 8 without the hod body 60 and in FIG. 9 without the sensor shroud 102. As may be seen, the sensor shroud 102 may include a first and optionally a second (or more) sensor 106, 108 which may be coupled to a sensor extender 110, for example, by a first and a second sensor retainer 112, 114, respectively. The position of the first and/or second sensors 106, 108 may be adjusted by moving the position of the first and second sensor retainers 112, 114 along the length of the sensor extender 110. By moving the position of one or more of the sensors 106, 108, the volume or quantity of fuel 13 which may be held in the hod cavity 32 may be adjusted. Alternatively, one or more of the sensors 106, 108 may include an adjustable level sensor which may detect the level of the fuel 13 inside the hod cavity 32. One or more of the sensors 106, 108 may include a capacitive proximity sensor, a pressure sensor, an ultrasonic sensor, optical sensor or the like which may be configured to sense the level of the fuel 13 within the chamber 32 for stopping the flow of fuel 13.

According to one embodiment, the system 10 (e.g., the hod PCB 104, register PCB 46, and/or a central controller) may be configured to shut off the flow of fuel 13 from the remote storage bin 12 prior to the desired volume or quantity of fuel 13 being reached inside the hod cavity 32. As may be appreciated, the feed line 24 includes a certain volume or quantity of fuel 13 while fuel 13 is being dispensed from the remote storage bin 12. The system may be configured to stop the flow of fuel prior to the hod cavity 32 reaching the desired level in order to accommodate the fuel 13 present within the feed line 24. The system may send a signal to shut the valve 28 of the remote storage bin 12. Once the fuel 13 in the feed line 24 has been removed from the feed line 24, the system may then shut off the vacuum source 18. As a result, blockage of the feed line 24 may be prevented due to accidental build up of undelivered fuel 13 in the feed line 24.

As may therefore be appreciated, the biomass transport system 10 may include a variety of features that may function as interlocks to control operation of the biomass transport system 10. The interlocks may control the operation of the remote storage bin 12 and/or the vacuum source 18 upon detection of a blockage or the like. The interlocks may also prevent inadvertent operation of the biomass transport system 10 by ensuring that the biomass transport system 10 will not operate unless the hod 20 is properly secured to the register 22 in order to prevent inadvertent operation as a vacuum, which could create safety issues if hot ash were accidentally sucked into the vacuum line, which may contain fine particulates of fuel.

Turning back to FIG. 1, the biomass transport system 10 may transport fuel 13 from the remote storage bin 12 to the hod 20 as described herein when the hod 20 is coupled to the register 22 in a first orientation or position. Once filled, the hod 20 may be disconnected from the register 22 and the fuel 13 may be easily transported to the appliance 16, where it may be combusted. The biomass transport system 10 may optionally include one or more sensors 110, 112 along the feed line 24 and/or the air line 26 configured to monitor the flow of materials therein and to determine if a blockage has occurred. For example, the biomass transport system 10 may include one or more sensors 110, 112 configured to monitor pressure drop within the feed line 24 and/or the air line 26. The sensors 110, 112 may also include auditory sensors, vibratory sensors, and/or optical sensors configured to detect the flow of fuel and/or air through the feed line 24 and/or the air line 26. The vacuum source 18 may also be provided with current sensors to determine the amount of power that the vacuum source is drawing. These sensors 110, 112 may transmit signals to the register PCB 46 and/or the hod PCB 104 which may be configured to analyze them to determine if a blockage has occurred and/or when the chamber 32 of the hod 20 is full. If a blockage has occurred, at least one of the central controller and/or PCBs 46, 104 may transmit a signal to the remote storage bin 12 to close valve 28. Optionally, the central controller and/or PCBs 46, 104 may transmit a signal to the vacuum source 18 to prevent damage (e.g., due to overheating) of the vacuum source 18.

The return air (i.e., air that flow from the hod 20 to the vacuum source 18) may be returned to the same space where it is pulled. This arrangement may minimize heat lost due to air changes in the area where the air is pulled. The return air may also be used to agitate the fuel 13 in the remote storage bin 12. For example, the return air may be used to create a fluidized bed within the remote storage bin 12. The fluidized fuel 13 within the remote storage bin 12 may facilitate dispensing of fuel 13 across the valve 28 by preventing blockages due to fuel build-up and the like. The valve 28 may include an electrically, pneumatically, and/or hydraulically controlled valve. Additionally, the remote storage bin 12 may be provided with one or more augers, vibrators or the like to prevent fuel blockages and/or meter out the fuel flow and control its feed rate and consequently, the air/fuel ratio.

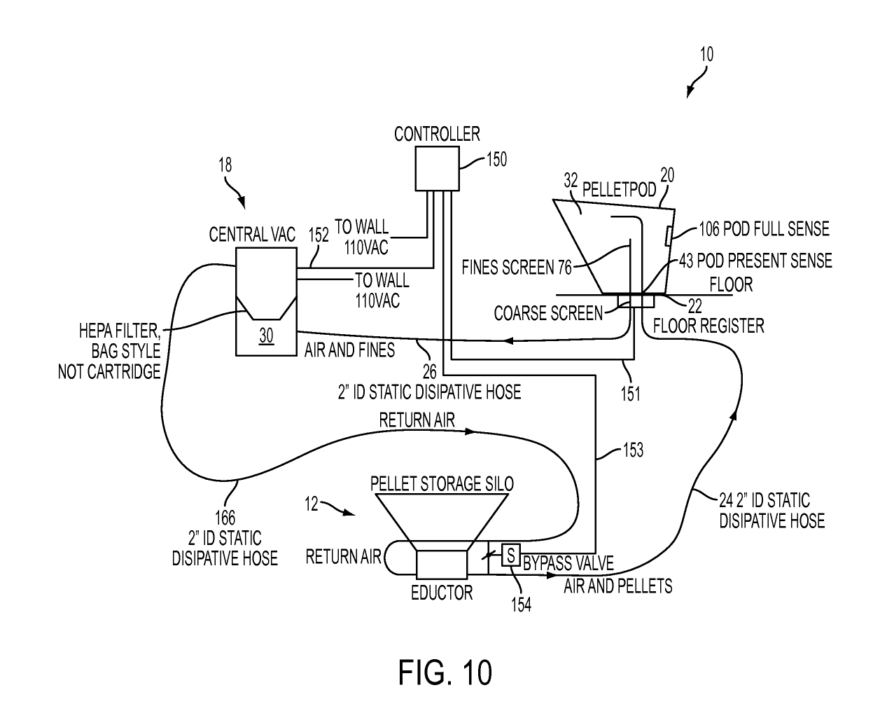

The biomass transport system 10 may optionally include a central controller 150, FIG. 10. The central controller 150 may be configured to receive signals 151 from the sensors in the sensor shroud 102 and may interpret these signals to detect when the chamber 32 of the hod 20 has reached a desired quantity/volume of fuel 13. The central controller 150 may be configurable based on user preferences. For example, a user may be able to configure/set the central controller 150 to select the desired quantity of fuel 13 to be dispensed into the cavity 32 of the hod 20, to select the desired fuel flow rate, the desired air flow rate, or even the desired type of fuel 13 or desired source of fuel (for example, if the system includes multiple remote storage bins 12). According to one embodiment, the central controller 150 may include a timer configured to provide a flow of fuel 13 from the remote storage bin 12 to the hod 20 based on a desired amount of fill time (which may be based on the fuel flow rate from the remote storage bin 12). The central controller 150 may also receive a signal 151 from the hod 20 and/or the register 22 to determine if the hod 20 is properly coupled to the register 22, to determine the position of the hod 20 relative to the register 22, and/or to determine the identity of the hod coupled to the register 22.

The central controller 150 may optionally be configured to receive and/or transmit a signal 152 to the vacuum source 18. The signal 152 may turn the power on/off to the vacuum source 18. Additionally, the central controller 150 may determine when the hod 20 is full based on the load experienced by the vacuum source 18. Optionally, the signal 152 may be configured to adjust the power to the vacuum source 18, for example, in order adjust the air/fuel flow rate within the system 10. The central controller 150 may also transmit a signal 153 to the remote storage bin 12 to regulate the flow of fuel 13. For example, the signal 153 may regulate a bypass valve 154 configured to adjust the flow of fuel 13 from the remote storage bin 12.

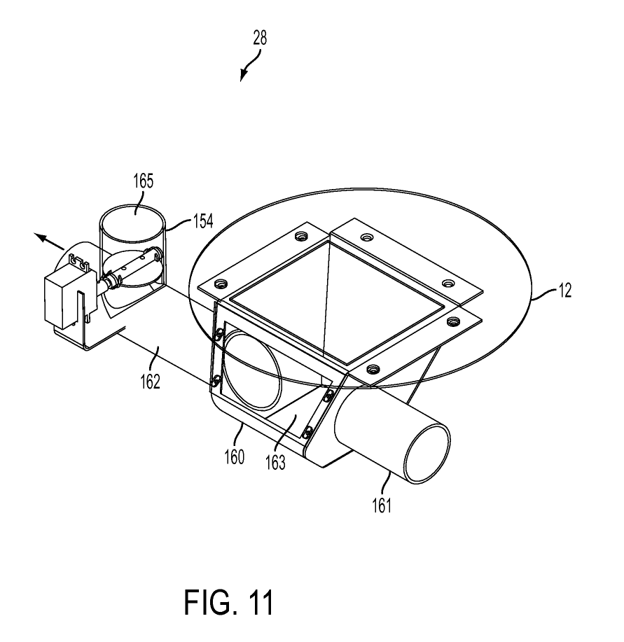

Turning now to FIG. 11, a cross-sectional view of one embodiment of a dispensing valve 28 consistent with present disclosure is generally illustrated. The dispensing valve 28 may comprise a fuel entrainer 160 having an air inlet 161 configured to selectively provide a flow of air into the fuel entrainer 160 and an air/fuel outlet 162 configured to selectively provide a flow of air and fuel out of the entrainer 160. For example, the air inlet 161 may be fluidly coupled to the vacuum source 18, for example, via a return air line 166 as illustrated in FIG. 10.

The fuel entrainer 160 may also be coupled to the remote storage bin 12, which may optionally include an isolation valve (not shown) configured to selectively dispense fuel 13 from the remote storage bin 12 into a chamber 163 defined by the fuel entrainer 160. The fuel entrainer 160 is configured to entrain/fluidize the fuel 13 with the air flowing through the air inlet 161 for transporting the fuel 13 to the hod 20 as described herein. A bypass valve 154 may be coupled to the air/fuel outlet 162. The bypass valve 154 may have an inlet 165 configured to be selectively provide a flow of air, and may optionally be coupled to the return air line 166 as illustrated in FIG. 10.

The bypass valve 154 may be configured to be selectively opened/closed in order to selectively provide a flow of air through the fuel entrainer 160 via the air inlet 161. In particular, when the bypass valve 154 is closed, air may flow into the fuel entrainer 160 through the air inlet 161. This flow of air may then fluidize the fuel 13 inside the chamber 163, which may ultimately exit the fuel entrainer 160 via the air/fuel outlet 162 where it may then be transported to the hod 20 as described herein. When the bypass valve 154 is opened, the flow of air through the fuel entrainer 160 may be reduced and/or substantially eliminated. As such, the rate of fuel dispensed from the remote storage bin 12 into line 24 may be controlled by controlling and/or modulating the opening/closing (e.g., duty cycle) of the bypass valve 154.

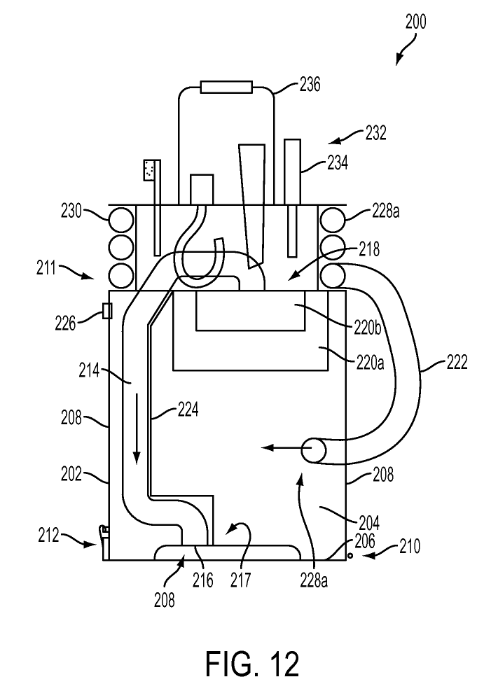

The biomass transport system 10 may also be configured to transport combustion products (e.g., ash) resulting from the combustion of the fuel 13 in the appliance 16. For example, the biomass transport system 10 may comprise an ash hod 200, FIG. 12, configured to be removably coupled to the register 22 (not shown in this picture for clarity). When the ash hod 200 is coupled to the register 22, the biomass transport system 10 may be configured to remove ash from an appliance 16 (e.g., a pellet stove or the like, not shown in this picture for clarity) and to separate/collect the ash from an incoming air stream. The ash may then be stored in an ash chamber 204 where it may be emptied. As may be appreciated, the volume of ash is a very small percentage compared to the original volume of the fuel 13 consumed in the appliance. For illustrative purposes, the ash hod 200 may be capable of storing an amount of ash corresponding to 10 (or more) loads of fuel 13 delivered to the appliance with the hod 20.

For example, the ash hod 200 may comprise a body portion 202 defining the ash cavity 204. The body portion 202 may also include a base portion 206 configured to be fluidly coupled to the register 22 and one or more sidewall portions 208. For example, the base portion 206 may comprise a recessed portion 208 configured to receive a portion of the register 22 (e.g., the base plate 38) and to at least partially sealingly engage the base plate 38. The base portion 206 may include an opening 216 configured to fluidly couple the ash hod 200 to the line 26 extending from the register 22 to the vacuum source 18 and to seal/cap-off the line 24 extending between the register 22 and the remote storage bin 12 such that the line 24 is not under vacuum. One or more portions of the body 202 may be configured to be at least partially removed to allow ash collected within the ash cavity 204 to be removed. For example, the base portion 206 may optionally include a hinge or the like 210 and/or one or more latches 212 or a sidewall may have a door that opens to allow ash to be removed or dumped.

The ash hod 200 may include a vacuum line 214 having a first end region 217 extending from the opening 216 in the recessed portion 208. A second end region 218 of the vacuum line 214 may be coupled to one or more filters 220a, 220b (e.g., but not limited to, a primary filer 220a configured to separate the larger ash particles from the air and a secondary filter 220b configured to remove the smaller, fine particles). The filters 220a, 220b may fluidly couple the second end region 218 of the vacuum line 214 to the ash cavity 204 and may be suspended from an upper portion 211 of the body 202 such that the ash may fall away from the filters 212a, 212b and towards the base portion 206.

As may be appreciated, ash may have a low pH (i.e., the ash may be acidic). In order to minimize the potential that the ash may damage the vacuum line 214, the vacuum line 214 may be separated from the ash cavity 204 such that the vacuum line 214 is not in contact with ash in the ash cavity 204. For example, the vacuum line 214 may be disposed about an outer surface of the body 202. Alternatively (or in addition), the vacuum line 214 may be housed in a secondary cavity 224. The secondary cavity 224 may be fluidly separated from the ash cavity 204. According to at least one embodiment, the secondary cavity 224 may include an auditory device (e.g., but not limited to, a whistle or the like 226). The auditory device 226 may provide an audible alarm in the event that there is a breach between the secondary cavity 224 and the ash cavity 204. In particular, in the event of a breach, the ash cavity 204 (which may be under vacuum) may draw air through the auditory device 226, which may then generate an audible alarm (e.g., a whistling sound) indicating that there the ash cavity 204 may be breached.

The ash hod 200 may also include an ash hose 222 fluidly coupled to the ash cavity 204. For example, the ash hose 222 may include a first end region 228a coupled to the ash cavity 204 at a position below the filters 212a, 212b. The first end region 228a may be configured to generally direct the ash towards the base portion 206, and generally away from the filters 212a, 212b to reduce the loading of the filters 212a, 212b. A second end region 228b of the ash hose 222 may be configured to drawn in ash and air from the appliance. The ash hose 222 may optionally be stored on the ash hod 200 using a hose reel or the like 230.

The ash hod 200 may optionally include a tool holder 232 configured to retain one or more tools 234 (e.g., but not limited to, tools that may be associated with servicing/emptying a pellet stove or the like such as screw drivers, wrenches, various sizes/shapes of vacuum wands that may optionally include integral scrapers and the like). Optionally, the ash hod 200 may include one or more handles or the like 236 coupled to the body 202. The handles 236 may facilitate movement and emptying of the ash hod 200.

In practice, the ash hod 200 may be fluidly coupled to the register 22. When coupled, the vacuum line 214 of the ash hod 200 may be fluidly coupled to the vacuum source 18, e.g., via line 26. The ash hod 200 may also seal/block-off the line 24 extending from the register 22 the remote storage bin 12. The vacuum source 18 may be activated, causing air to be drawn down line 26 and vacuum line 214, causing a vacuum inside the ash cavity 204. Air and ash may then be drawn in the ash cavity 204 via the ash hose 222. The air and ash may then enter the ash cavity 204, and the air may be separated from the ash via filters 212a, 212b such that only the air is allowed to enter the vacuum line 214. As may be appreciated, it is important to prevent hot ash from being sucked into the vacuum source 18. The system may also include a verification of pressure drop across one or more of the filters 220a and 220b to confirm that there is actually a filter in place and therefore prevent as from accidentally passing into the vacuum line. Feedback from a pressure differential transducer between second end region 218 and ash cavity 204 may confirm separation of ash is actually occurring. The system may also be configured to confirm independently each filter 220a, 220b is present and in good working order, for example, using multiple pressure transducers or the like.

The ash hod 200 may also include sensors and circuitry as described herein to control the vacuum source 18 (e.g., provide interlocks) and/or to identify the ash hod 200 (e.g., to allow the system 10 to differentiate between an ash hod 200 and a hod 20) as generally described herein. The system may determine if the filter(s) 220 are in place by monitoring/verifying a pressure drop across the filters 200 before turning on the system (e.g., before turning on the vacuum source 18 and/or applying vacuum within the ash hod 200). For example, a valve may be disposed upstream of the external air and ash hose. When the system starts, this valve may not be connected to the external ash and vacuum hose, but instead may be coupled to a separate filtered and/or concealed air inlet. Once pressure drop across the filters is first verified, the valve may connect the external ash and vacuum hose to the negative pressure, and vacuuming could commence.

As used herein, the term “fines” is intended to refer to particles which may flow through a ¼″ mesh screen. For example, fines may include particles which may flow through a generally square 3/16″ opening or a ⅛″ screen.

According to one aspect, the present disclosure may feature a biomass transfer system comprising a register and a hod. The register may be configured to be coupled to a support surface and may comprise a first pipe configured to be fluidly coupled to a remote storage bin, the remote storage bin configured to contain a quantity of bulk solid biomass fuel; and a second pipe configured to be fluidly coupled to vacuum source. The hod may be configured to be removably fluidly coupled to the register. The hod may comprise a body defining a sealed cavity configured to store a user selected quantity of the bulk solid biomass fuel; a feed pipe coupled to the sealed cavity, the feed pipe configured to be fluidly coupled to the first pipe to receive air and the bulk solid biomass fuel from the remote storage bin; and an air pipe disposed within the sealed cavity, the air pipe configured to be fluidly coupled to the second pipe such that substantially only air and fine particles exit the sealed cavity and the bulk solid biomass fuel is stored within the sealed cavity.

According to another aspect, the present disclosure may feature a biomass transport system comprising a remote storage bin, a vacuum source, and a biomass transfer system. The remote storage bin may be configured to contain a quantity of bulk solid biomass fuel. The remote storage bin may comprise a controllable dispensing valve configured to dispense a controlled rate of the bulk solid biomass fuel into a first pipe. The vacuum source may be configured to provide a stream of air through a second pipe. The biomass transfer system may comprise a register configured to be coupled to a support surface and a hod. The register may comprise a first opening configured to be fluidly coupled to the first pipe and a second opening configured to be fluidly coupled to the second pipe. The hod may be configured to be removably fluidly coupled to the register. The hod may comprise a body defining a sealed cavity configured to store a user selected quantity of the bulk solid biomass fuel; a feed pipe coupled to the sealed cavity, the feed pipe configured to be fluidly coupled to the first opening to receive air and the bulk solid biomass fuel from the remote storage bin; and an air pipe disposed within the sealed cavity, the air pipe configured to be fluidly coupled to the second opening such that substantially only air and fine particles exit the sealed cavity and the bulk solid biomass fuel is stored within the sealed cavity.

According to yet a further aspect, the present disclosure may feature a method of transporting a bulk solid biomass fuel. The method may comprise providing a remote storage bin configured to contain a quantity of bulk solid biomass fuel; providing a hod comprising a body defining a sealed cavity, a feed pipe disposed within the sealed cavity, and an air pipe coupled to the sealed cavity; fluidly coupling the feed pipe to a first pipe coupled to the remote storage bin; fluidly coupling the air pipe to a second pipe coupled to a vacuum source; applying a vacuum to the second pipe to create a flow of air and dispensing a controlled rate of bulk solid biomass fuel from the remote storage bin into the first pipe using a controllable dispensing valve; and separating the bulk solid biomass fuel from the flow of air such that substantially only air and fine particles exit the sealed cavity through the second pipe and the bulk solid biomass fuel is stored within the sealed cavity.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

Additional disclosure in the format of claims is set forth below:

What is claimed is:

1. A biomass transfer system comprising:
a register configured to be coupled to a support surface, said register comprising:
a first pipe configured to be fluidly coupled to a remote storage bin, said remote storage bin configured to contain a quantity of bulk solid biomass fuel; and
a second pipe configured to be fluidly coupled to vacuum source; and
a hod configured to be removably fluidly coupled to said register, said hod comprising:
a body defining a sealed cavity configured to store a user selected quantity of said bulk solid biomass fuel;
a feed pipe coupled to said sealed cavity, said feed pipe configured to be fluidly coupled to said first pipe to receive air and said bulk solid biomass fuel from said remote storage bin; and
an air pipe disposed within said sealed cavity, said air pipe configured to be fluidly coupled to said second pipe such that substantially only air and fine particles exit said sealed cavity and said bulk solid biomass fuel is stored within said sealed cavity.

2. The biomass transfer system of claim 1, wherein said bulk solid biomass fuel comprises wood pellets.

3. The biomass transfer system of claim 1, wherein said hod further comprises a lid hingedly coupled to said body portion and configured to remove said solid biomass fuel from said sealed cavity.

4. The biomass transfer system of claim 2, further comprising a seal disposed between said lip and said body for sealing said lip and said sealed cavity.

5. The biomass transfer system of claim 1, wherein said feed pipe includes an arcuate portion configured to separate said bulk solid biomass fuel and from said air.

6. The biomass transfer system of claim 5, wherein said arcuate portion is configured to direct said flow of air and bulk solid biomass fuel substantially parallel to a base portion of said sealed cavity.

7. The biomass transfer system of claim 5, wherein said arcuate portion is configured to direct said flow of air and bulk solid biomass fuel substantially towards a base portion of said sealed cavity.

8. The biomass transfer system of claim 1, wherein said air outlet comprises a filter, said filter configured to substantially prevent said bulk solid biomass fuel from entering said air outlet.

9. The biomass transfer system of claim 8, wherein said filter comprises a self-shedding, relatively coarse filter configured to pass fine particles included with said bulk solid biomass fuel.

10. The biomass transfer system of claim 1, further comprising one or more handles coupled to an external surface of said body.

11. The biomass transfer system of claim 1, further comprising at least one sensor configured to generate a signal, said signal configured to stop the flow of said bulk solid biomass fuel into said sealed cavity.

12. The biomass transfer system of claim 1, further comprising a timer configured to generate a signal, said signal configured to stop the flow of said bulk solid biomass fuel into said sealed cavity.

13. The biomass transfer system of claim 1, wherein said register is configured to determine when said feed inlet and said air outlet of said hod are fluidly coupled to said first and said second pipes, respectively, and when coupled, configured to transmit a signal to start the flow of said bulk solid biomass fuel into said sealed cavity.

14. The biomass transfer system of claim 1, wherein said register further comprises a base plate and wherein said hod further comprises a guide plate, wherein said guide plate is configured to receive at least a portion of said base plate and to align said feed inlet and said air outlet of said hod with said first and said second pipes, respectively.

15. The biomass transfer system of claim 14, wherein said guide plate further comprises at least one electrical connector for receiving electrical signals from said hod.

16. The biomass transfer system of claim 1, wherein said register is configured to determine an orientation of said hod when said hod is coupled to said register.

17. The biomass transfer system of claim 1, further comprising at least one interlock configured to stop the flow of said bulk solid biomass fuel to said hod if the hod is not fluidly coupled to said register.

18. A biomass transport system comprising:
a remote storage bin configured to contain a quantity of bulk solid biomass fuel, said remote storage bin comprising a controllable dispensing valve configured to dispense a controlled rate of said bulk solid biomass fuel into a first pipe;
a vacuum source configured to provide a stream of air through a second pipe; and
a biomass transfer system comprising:
a register configured to be coupled to a support surface, said register comprising:
a first opening configured to be fluidly coupled to said first pipe; and
a second opening configured to be fluidly coupled to said second pipe; and
a hod configured to be removably fluidly coupled to said register, said hod comprising:
a body defining a sealed cavity configured to store a user selected quantity of said bulk solid biomass fuel;
a feed pipe coupled to said sealed cavity, said feed pipe configured to be fluidly coupled to said first opening to receive air and said bulk solid biomass fuel from said remote storage bin; and
an air pipe disposed within said sealed cavity, said air pipe configured to be fluidly coupled to said second opening such that substantially only air and fine particles exit said sealed cavity and said bulk solid biomass fuel is stored within said sealed cavity.

19. The biomass transport system of claim 18, further comprising at least one interlock configured to stop the flow of said bulk solid biomass fuel from said remote storage bin to said hod.

20. A method of transporting a bulk solid biomass fuel comprising:
providing a remote storage bin configured to contain a quantity of bulk solid biomass fuel;
providing a hod comprising a body defining a sealed cavity, a feed pipe disposed within said sealed cavity, and an air pipe disposed within said sealed cavity;
fluidly coupling said feed pipe to a first pipe coupled to said remote storage bin;
fluidly coupling said air pipe to a second pipe coupled to a vacuum source;
applying a vacuum to said second pipe to create a flow of air and dispensing a controlled rate of bulk solid biomass fuel from said remote storage bin into said first pipe using a controllable dispensing valve; and
separating said bulk solid biomass fuel from said flow of air such that substantially only air and fine particles exit said sealed cavity through said second pipe and said bulk solid biomass fuel is stored within said sealed cavity.

21. A biomass transport system comprising:
a vacuum source configured to provide a stream of air through a first pipe; and
a biomass transfer system comprising:
a register configured to be coupled to a support surface, said register comprising a first opening configured to be fluidly coupled to said first pipe; and
an ash hod configured to be removably fluidly coupled to said register, said hod comprising:
a body defining a sealed ash cavity configured to store ash;
a vacuum pipe comprising a first end region configured to be fluidly coupled to said first opening to receive air from said ash cavity and a second end region configured to be fluidly coupled to said ash cavity;
at least one filter coupled to said second end region of said vacuum pipe; and
an ash hose configured to be fluidly coupled to said ash cavity, said ash hose further configured to receive air and ash from an appliance, wherein said ash is separated by said filter and collected in said ash cavity and substantially only said air is drawn into said vacuum pipe.

22. The biomass transport system of claim 21, wherein said register further comprises a second opening coupled to a second pipe, said second pipe further coupled to a remote storage bin; and
wherein said ash hod is further configured to seal said second opening when said ash hod is coupled to said register.

23. The biomass transport system of claim 21, wherein vacuum line is disposed within a secondary cavity, said secondary cavity being sealed from said ash cavity.

24. The biomass transport system of claim 21, wherein said at least one filter is disposed from a top surface of said ash cavity and wherein said ash is configured to be collected about a bottom surface of said ash cavity.

25. The biomass transport system of claim 21, further comprising at least one interlock configured to verify the presence of said at least one filter and to prevent said vacuum source from providing said stream of air if said at least one filter is not detected.

26. The biomass transport system of claim 25, wherein said at least one filter is detected by monitoring a pressure drop.
